(19) United States
(12) Patent Application Publication
(10) Pub. No.: US 2008/0075520 A1
(43) Pub. Date: Mar. 27, 2008

(54) STACKABLE CHALK HOLDER

(76) Inventor: Jeffrey Grossman, Lake Bluff, IL (US)

Correspondence Address: SACHNOFF & WEAVER, LTD., 10 SOUTH WACKER DRIVE, CHICAGO, IL, 60606-7507, US

(21) Appl. No.: 11/860,096

(22) Filed: Sep. 24, 2007

Related U.S. Application Data
(60) Provisional application No. 60/826,667, filed on Sep. 22, 2006.

(51) Int. Cl. B43K 23/016

(52) U.S. Cl. 401/89

(57) ABSTRACT

A support for writing material comprising a hollow casing having open upper and lower ends. A plurality of holders for writing material, such as sidewalk chalk, are releasably, frictionally and moveably disposed in a stack in the hollow casing, wherein each holder is adapted to removeably and securely hold a piece of writing material in a first partition of each holder. Each holder also has a second partition separated from the first partition, said second partition providing a hollow volume adapted to receive the writing material held by a lower adjacent holder. Each holder may hold writing material of the same color, or of varying colors. By applying finger pressure to the hollow lower partition of the lowermost holder in the casing, the writing material in the uppermost holder is frictionally advanced beyond the upper open end of the casing, and the writing material is applied by the user to a sidewalk or other selected surface.

### CROSS REFERENCE TO RELATED APPLICATIONS

This application claims priority from provisional application No. 60/826,667 filed on Sep. 22, 2006 to the extent allowed by law.

### FIELD OF THE INVENTION

The present invention relates to a holder for writing or drawing materials, such as chalk or the like, where multiple writing materials can be stacked linearly in the holder and held firmly in place while in use or while in storage.

### BACKGROUND OF THE INVENTION

A common children's toy for generations is sidewalk chalk. Sidewalk chalk typically consists of a stick or cylinder of material which can mark sidewalks or similar surfaces made of cement, concrete or asphalt. Sidewalk chalk is often used to draw pictures on cement, asphalt, concrete, or another surface. A sidewalk chalk holder typically comprises a plastic case which covers and protects the chalk on all sides except an extending writing tip. When using sidewalk chalk or another writing material, it will eventually become necessary to push the chalk or writing material upward to make additional writing material accessible as the chalk or writing material is used up, in order to continue marking images on a surface. It may also become necessary to replace the chalk or writing material with another piece if no writing material remains available in the casing, or if chalk or writing material of a different color is desired. Therefore, a need exists for a chalk holder which provides storage for multiple pieces of chalk or other writing material for continued and prompt use after an initial piece of chalk or writing material has been used in its entirety. Additionally, there is a need for a stackable chalk holder which provides an easy method for pushing chalk or other writing materials upward for continued accessibility.

### SUMMARY OF THE INVENTION

The present invention is directed to a stackable holder or support for writing materials, particularly large pieces of chalk commonly known as sidewalk chalk. The stackable holder is designed for use in marking images on sidewalk surfaces made of concrete, cement, asphalt or the like, and other writing surfaces. Use of the stackable holder allows extra pieces of chalk or other writing materials of the same or varying colors to be made available for use, storage, and transport.

The stackable chalk holder or support comprises a casing or housing sized to fit individual holders that are vertically stacked and aligned in the casing. A removable cap fits tightly over the upper end of the casing in snapping engagement. A clip is attached to the cap for connection to a backpack or belt for easier transport of the stackable holder. The clip further extends over an outer wall of the casing when the cap is in place on the casing.

In one embodiment, the casing or housing of the present invention has a cylindrical or tubular shape, an outer wall, an inner wall, and an open upper end and lower end providing access to the interior of the casing. The casing has a longitudinal or center axis extending through the upper and lower ends, the center axis being coaxial with the longitudinal axis of a plurality of individual holders. The writing material is held within the individual holders in a linear arrangement relative to the upper end and lower end of the casing.

In one embodiment, three vertical ribs extend along the entire length of the inner wall of the casing, which ribs function to exert pressure on the outer wall of each of the individual holders or other contents of the casing to frictionally resist movement or shifting of the writing materials until a force is physically applied to the holders by a user.

Each individual holder has an upper end, a lower end, an inner wall, and an outer wall. In an embodiment of the present invention, the individual holders have a generally cylindrical shape to hold chalk, and are adapted to be axially movable in the casing. Each individual holder is further separated into an upper partition and a lower partition by a horizontal plate adjacent to and connected to the inner wall of the individual holder. The upper partition is adapted to support chalk or other writing material for use while in the casing. The lower partition provides an open volume in the holder to receive chalk extending from the lower adjacent holder while the holders and chalk are in the stacked position. Alternatively, the lower partition can remain open, particularly if disposed at the bottom of a vertical stack in the casing, and provide a location for a user to push on the stack of chalk holders with a thumb, finger, or other apparatus in an upward motion to make the chalk or other writing material extend from the open upper end and be accessible for use.

### BRIEF DESCRIPTION OF THE DRAWINGS

The features and inventive aspects of the present invention will become more apparent upon reading the following detailed description and drawings, of which the following is a brief description:

FIG. 1 is a front perspective view of the stackable chalk holder of the present invention, where the cap is in place on the casing and three pieces of chalk in individual holders are stacked vertically;

FIG. 2 is a front perspective view of the stackable chalk holder of the present invention as shown in FIG. 1, with the cap removed and a piece of chalk accessible for use;

FIG. 3 is a front elevation view of the casing for the stackable chalk holder of the present invention;

FIG. 4 is a top view of the casing shown in FIG. 3;

FIG. 5 is a front cut-away section view of a second embodiment of the present invention with the cap removed and four pieces of chalk stacked vertically, the top piece of chalk accessible for use;

FIG. 6 is a front perspective view of an individual holder grasping a piece of chalk, the individual holder forming part of the present invention;

FIG. 7 is a front view of the cap and clip of the present invention;

FIG. 8 is a side view of the cap and clip shown in FIG. 7;

FIG. 9 is a top view of the cap and clip shown in FIG. 7;

FIG. 10 is a front cut-away section view of the second embodiment of the invention as shown in FIG. 5 with the cap in place on the casing.

### DETAILED DESCRIPTION OF THE INVENTION

A detailed description of the present invention is described herein with reference to the accompanying drawing figures.

The present invention is directed to a stackable holder or support for writing materials, particularly large pieces of chalk commonly known as sidewalk chalk. The stackable holder is designed for use in marking images on cement, concrete, asphalt and other writing surfaces, such as floors, sidewalks, pavements, streets, and other such surfaces. The stackable holder is durable and easy to produce, manufactured from a rigid material such as polyvinyl chloride, other plastic, or other suitable material. The presence of multi-colored chalk or drawing materials held in the invention at the option of the manufacturer or the user provides an attractive and appealing toy, game or novelty item for children and adults. Use of the stackable holder allows extra pieces of chalk or other writing materials, or chalk or writing materials of varying colors, to be made available for use, storage, and transport.

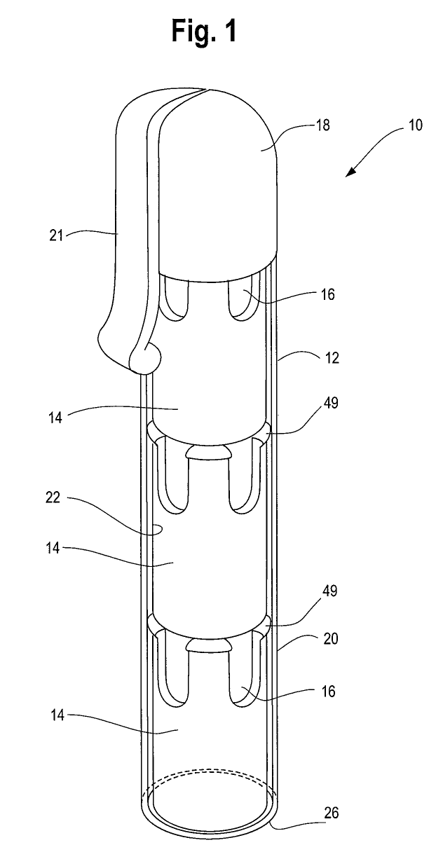

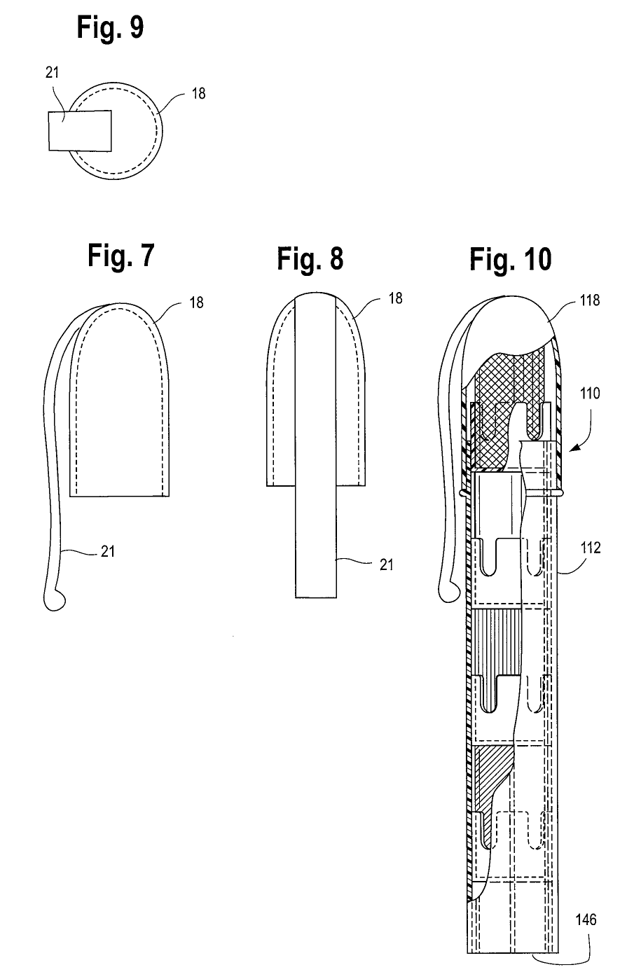

As shown in FIGS. 1-5, the stackable chalk holder or support for writing materials 10 comprises a casing or housing 12 having a generally straight tubular or cylindrical shape and sized to fit individual holders 14 vertically stacked in the casing 12. One of ordinary skill in the art will appreciate that the casing or housing 12 for the stackable holders 14 can be designed in a variety of shapes, of which the cylindrical design of the present invention is merely an example. In the illustrated embodiments, the casing 12 is transparent, showing the colors of the chalk pieces 16 in the casing. However, the casing may be opaque and of any color if desired. Further, a removable cap 18 fits tightly over the upper end 24 of the casing 12 in snapping engagement as best seen in FIGS. 1 and 10. A clip 20 (FIGS. 7-9) is attached to the cap 18 for connection to a backpack, or belt pocket for easier transport of the stackable holder. The clip 20 extends over the outer wall 20 of the casing when the cap is in place on the casing.

In FIGS. 1-4, the casing or housing 12 of the present invention has a cylindrical or tubular shape, an outer wall 20, an inner wall 22, an open upper end 24, an open lower end 26, and an aperture 28 at both upper and lower ends providing access to the interior of the casing 12. The casing 12 has a longitudinal or center axis extending through the upper and lower ends coaxial with a longitudinal axis of the individual holders 14, and the writing material is held within the individual holders in a linear array or arrangement relative to the upper end 24 and lower end 26 of the casing 12.

The casing 12 may be manufactured to different lengths to suit different applications and market demand. Typically the casing has an internal diameter of up to 2 in. for receiving and firmly holding pieces of chalk or other writing material, but other diameters may be selected for different applications. In the illustrated embodiment shown in FIGS. 1-4 the casing 12 has a length of approximately 5.75 inches and an internal diameter of approximately 1.25 inches.

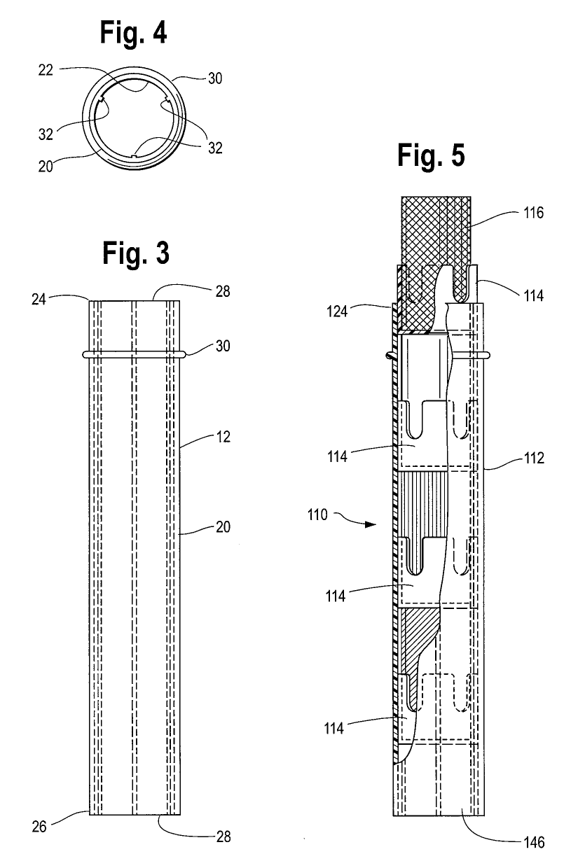

A horizontal rim 30 (FIG. 4) is mounted on the outer wall 20 of the casing 12 and around the circumference of the casing 12 to provide a snapping contact and a resting position for the cap 18 when placed on the holder 10 as best seen in FIGS. 3-4. In one embodiment, three vertical ribs 32 (FIG. 4) extend along the entire length of inner wall 22 of the casing 12, which ribs function to exert pressure on the outer wall of the individual holders 14 or other contents of the casing to frictionally resist movement or shifting of the writing material holders until physically pushed by a user. The ribs 32 frictionally engage the outer wall of each individual holder 14, or other apparatus inside the casing 12, and exert pressure to hold the individual holders 14 in place while allowing selected frictional movement of the individual holders 14 under finger pressure.

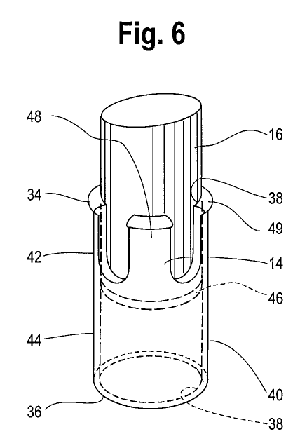

Referring to FIG. 6, each individual holder 14 has an upper end 34, a lower end 36, an inner wall 38, and an outer wall 40. In the illustrated embodiment, (FIG. 6) each individual holder 14 before insertion of chalk 16 has a length of approximately 2 inches and a total length of approximately 3 inches when the chalk 16 is inserted and accessible for writing above the upper end 34 of the individual holder 14. The diameter of the individual holder 14 is generally sized to fit the chalk or other writing material intended for use. In the illustrated embodiment of FIG. 6, the diameter of the individual holder 14 is approximately one inch. One of ordinary skill in the art will appreciate that the individual holders 14 can have varying lengths and diameters, appropriate for the particular application. One of ordinary skill in the art will also appreciate that the individual holder can have various shapes and designs in coordination with the selected shape of the casing 12. In the illustrated embodiment of the present invention, the individual holders 14 have a generally cylindrical shape to hold chalk 16 and to be stored in the casing 12. The individual holders can be manufactured from any material which can be flexed such as plastic, rubber, or the like.

Each individual holder 14 (FIG. 6) is separated into an upper partition 42 and a lower partition 44 by a horizontal plate 46 adjacent to and connected to the inner wall 38 of the individual holder 14 around the circumference of the individual holder 14, and perpendicular to the plane of the walls 38, 40. The upper partition 42 is adapted to support chalk 16 for use while the chalk is in the casing 12. The lower partition 44 provides an open volume to receive chalk 16 extending from the lower adjacent holder 14 while in the stacked position in casing 12. Alternatively, the lower partition 44 can remain open as at 146 (best seen in FIGS. 5 and 10), particularly if at the bottom of a vertical stack in the casing. Open partition 146 provides a location for a user to push on the chalk with a thumb, finger, or other apparatus in an upward motion. Pushing on the chalk at location 146 advances the chalk 16 or writing material upward above the end 24 of the casing 12 against the friction force applied to each holder 14 by ribs 32 on the interior surface 22 of casing 12. This makes the chalk 16 accessible for writing on a surface. Further, the inner walls 38 and outer walls 40 (FIG. 6) of at least one of the partitions have arm-like extensions 48 which flex when the chalk 16 is inserted. The extensions 48 hold the chalk 16 firmly in place in the individual holder 14 by exerting frictional pressure from the inside wall of casing 12, which pressure is applied to laterally extending flanges 49 located at the top of each extension 48. In the illustrated embodiment (FIG. 6), the upper partition 42 has arm-like extensions 48 which flex when the chalk 16 is inserted, and hold the chalk 16 firmly in place as described.

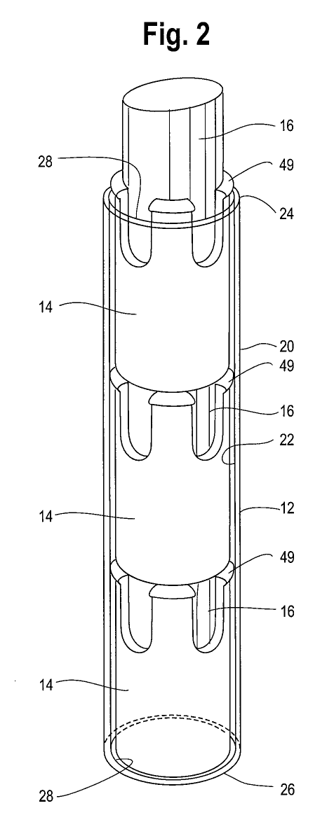

Each individual holder 14 movably and frictionally fits in the casing 12. The casing size may vary for different applications. The length of each individual holder 14 is fractionally less than that of the casing 12. The diameter of each holder 14 is nearly equal to that of the casing such that the holders 14 maintain continuous connection along the inner walls 22 and the ribs 32 of the casing to remain in place until pushed or moved at the user's discretion. In the illustrated embodiment of FIGS. 1 and 2, the casing is sized to fit three individual holders 14 for chalk or other writing material desired by the user.

FIG. 5 and FIG. 10 illustrate an alternate embodiment of the present invention. FIG. 5 shows the stackable holder 110 having a casing 112 sized to fit four individual holders 114. In FIG. 5 the cap 118 is removed and chalk 116 is accessible and ready for use above the upper end 124 of the casing 112. FIG. 10 shows the second embodiment with the cap 118 in place tightly over the upper end 124 of casing 112 for storage or transport.

In operation, a user holds the casing 12 in any comfortable position with one or both hands. Cap 18 is disengaged from horizontal rim 30 on casing 12, and the cap is removed from the casing. The user pushes on the empty partition 44 of the lowest individual holder 14 at the lower end 26 of the casing 12, such that the chalk 16 in each individual holder 14 is advanced in the direction of the upper end 24 of the casing 12 to become visible and accessible over the upper end 24 of the casing 12 for writing on a surface. When a user desires to switch the chalk holder (for a new color or to refill the holder with chalk), the individual holder 14 at the upper end 24 of the casing 12 is pushed upward from the bottom of casing 12. The upper individual holder 14 is removed and re-inserted into the lower end 26 of the casing again (or a refill is obtained), pushing upward relative to the casing 12 such that the next or second chalk holder or other writing material in the casing 12 is advanced upward in the direction of the upper end 24 of the casing 12 and becomes accessible for use above the upper end 24 of the casing 12. After the chalk holder 10 has been used, cap 18 is replaced with a snap fit at the upper end of casing 12.

With respect to the above description herein, it is to be realized that the optimum dimensional relationships for the parts of the invention, to include variations in size, materials, shape, form, function, and manner of operation, assembly and use, are deemed readily apparent and obvious to one skilled in the art, and all equivalent relationships to those illustrated in the drawings and described in the specification are intended to be encompassed by the present invention.

Therefore, the foregoing detailed description of the invention is intended to be illustrative and not intended to limit the scope of the invention. Changes and modifications are possible with respect to the foregoing description, and it is understood that the invention may be practiced otherwise than that specifically described herein and still be within the scope of the invention.

I claim:

1. A support for writing material, comprising:
a. a hollow casing having open upper and lower ends;
b. at least one holder reasonably, frictionally and moveably disposed in said hollow casing, said at least one holder adapted to removably and securely hold said writing material in a first partition of said at least one holder;
c. said at least one holder having a second partition separated from said first position, said second partition providing a hollow volume of said at least one holder.

2. The support for writing material of claim 1 wherein:
a. Said hollow casing has a first longitudinal axis extending the length of the hollow casing;
b. Said at least one holder having a second longitudinal axis extending the length of the at least one holder;
c. the longitudinal axis of the at least one holder in co-axial alignment with the longitudinal axis of the hollow casing.

3. The support for writing material of claim 2, wherein the at least one holder is moveable along the longitudinal axis of the hollow casing.

4. The support for writing material of claim 2, wherein said at least one holder is adapted to extend and expose a portion of said writing material beyond said open upper end of said hollow casing.

5. The support of claim 1 wherein the hollow casing further comprises a tubular-shaped configuration.

6. The support of claim 1, further comprising a removable cap attached to and in snapping engagement with the open upper end of the hollow casing.

7. The support of claim 6 further comprising a securing clip attached to the removable cap, said securing clip extending from said cap along an outer surface of said casing when said cap is positioned on said casing.

8. The support of claim 2 wherein the at least one holder comprises a plurality of holders removably and frictionally stacked in a linear arrangement aligned with the longitudinal axis of the casing, each of said plurality of holders having a hollow lower partition, the hollow lower partition adapted to receive the writing material held by a lower adjacent holder.

9. The support of claim 8 wherein one of the plurality of holders in the linear arrangement located near the open lower end of the casing has a hollow lower partition adapted to allow a user to push upward on the holder to advance the writing material held in another of the plurality of holders upward above the upper end of the casing.

10. The support of claim 1 further comprising at least one rib extending along at least a portion of a length of an inner wall of the casing, the at least one rib in frictional engagement with the outer wall of the at least one holder and exerting pressure on an outer wall of the at least one holder.

11. The support of claim 8 wherein the at least one holder further comprises an upper partition separated from the lower partition by a horizontal plate, the horizontal plate adjacent to and connected to the inner wall of the at least one holder, the upper partition adapted to support writing material for use while in the casing.

12. The support of claim 11 wherein the upper partition on each of the at least one holder comprises flexible extensions adapted to hold said writing material firmly in place.

13. The support of claim 12 wherein said flexible extensions include a laterally extending flange adapted to engage at least one rib extending along at least a portion of a length of an inner wall of the casing, said engagement adapted to apply lateral pressure to said writing material and to secure said writing material in said at least one holder.
